(19) United States
(12) Patent Application Publication
(10) Pub. No.: US 2004/0187328 A1
(43) Pub. Date: Sep. 30, 2004

(54) Method and device for measuring directional, and computer program

(75) Inventors: Masahiro Satoh, Iruma-shi (JP); Kazuhiko Terashima, Tokyo (JP); Junji Satoh, Kawagoe-shi (JP)

Correspondence Address: SUGHRUE MION, PLLC, 2100 PENNSYLVANIA AVENUE, N.W., SUITE 800, WASHINGTON, DC, 20037, US

(73) Assignee: CITIZEN WATCH CO., LTD

(21) Appl. No.: 10/809,546

(22) Filed: Mar. 26, 2004

(30) Foreign Application Priority Data
Mar. 27, 2003 (JP) 2003-86843
Feb. 17, 2004 (JP) 2004-40502

(51) Int. Cl. G01C 17/38

(52) U.S. Cl. 33/356

(57) ABSTRACT

A method for measuring a directional of a body in a three-dimensional space defined by an X-axis (magnetic north), a Y-axis, and a Z-axis is proposed. An x-axis tilt angle, which is an angle between a horizontal plane and an x-axis, which is the direction towards which the body points, and a y-axis tilt angle, which is an angle between a y-axis orthogonal to the x-axis and the horizontal plane, are detected. The x-axis and the y-axis are converted so as to be in the horizontal plane using the x-axis tilt angle and the y-axis tilt angle. A primary azimuth between the X-axis and the x-axis converted is calculated. An azimuth error angle included in the primary azimuth is extracted based on the x-axis tilt angle, the y-axis tilt angle, and the primary azimuth.

### BACKGROUND OF THE INVENTION

1) Field of the Invention

The present invention relates to a technology for measuring a directional (i.e., direction and position) of an object in a three-dimensional space.

2) Description of the Related Art

The directional measuring devices, also called the electronic compasses, detect geomagnetic forces in each of a plurality of directions using a magnetic sensor corresponding to each direction and calculate a direction to be observed, i.e., a directional of an observation axis from the result of detection. Such directional measuring devices are used in cell phones, portable information terminals such as personal digital assistants (PDAs), wrist watches, car navigation systems such as vehicle compasses, attitude detectors for airplanes, directional measuring devices for visually impaired persons, and even game machines.

Particularly, position information service for the portable information terminals has been started recently. In the position information service, a present position of a portable information terminal is displayed on a screen of the portable information terminal along with a map of a surrounding area so that the user of the portable information terminal can locate his/her present position. By thus combining the directional measuring device with the portable information terminal on which the position information service can be enjoyed, it becomes possible for a user to recognize to which direction he/she is facing or to which direction he/she is going. The information providing service that employs the position information service and the directional measuring device is expected to create a lot of new business opportunities in various industrial fields in near future, and the other hand, the users are privileged by getting useful information. However, the spreading of the information providing service requires the precision of the directional measuring device to be increased from what it is at present.

The directional measuring devices have a drawback that an azimuth cannot be precisely measured if the directional measuring devices are in tilted posture. The users of the directional measuring devices may use them or hold them in various ways, and it is quite possible that a user holds his/her directional measuring device in such a manner that a magnetic sensor in the directional measuring device is in a tilted posture. If the magnetic sensor is in a tilted posture, although the observation axes indicate the identical azimuth, an output of the magnetic sensor changes according to an amount of the tilt, and therefore, an error may occur in calculation of the azimuths.

For example, if a biaxial magnetic sensor, which corresponds to an x-axis and a y-axis orthogonal to the x-axis, is rotated around a vertical axis so that the x-axis and the y-axis tilt by a certain tilt angle with respect to the x-y plane, the output of the biaxial magnetic sensor cannot be expressed by simple sine waveform and cosine waveform but can only be expressed with complex waveforms depending on factors such as a dip of the tilt angle. Consequently, an azimuth θ (obtained with θ=arctan (y/x)) calculated from the output of the biaxial magnetic sensor is erroneous.

Japanese Patent Application Laid Open No. 2002-196055 (see page 5, equation 2) discloses an omnidirectional magnetic sensor capable of automatically correcting a tilt and precisely calculating the direction. FIG. 10 is a flowchart of a process procedure disclosed in the above-mentioned literature. As shown in this flowchart, three magnetic vectors corresponding to three dimensions (hereinafter, “three-dimensional magnetic vectors”) are acquired from the output of the magnetic sensor (step S1001). A pitch angle and a roll angle of the body of the magnetic sensor are acquired from the output of a tilt sensor (step S1002). Coordinate transformation is performed twice to the coordinates of the three-dimensional magnetic vectors using the pitch angle and the roll angle to calculate a magnetic vector of a horizontal magnetic field component (step S1003). An azimuth is calculated from the magnetic vector of the horizontal magnetic field component (step S1004).

More specifically, the omnidirectional magnetic sensor employs a method of rotating the geomagnetic vector to the horizontal magnetic field component using the rotational transformation. In the rotational transformation, a product of a rotation matrix used to rotate the body of the omnidirectional magnetic sensor around the X-axis and a rotation matrix used to rotate the body around the Y-axis in an absolute coordinate system is used. The absolute coordinate system includes the X-axis that points towards the magnetic north on a horizontal plane, the Y-axis that is orthogonal to the X-axis on the horizontal plane, and the Z-axis that is orthogonal to the horizontal plane. A observation coordinate system that includes an x-axis that is the direction towards which the body points, a y-axis that is orthogonal to the x-axis, and a z-axis that is orthogonal to the x-axis and the xy plane. The rotational transformation is performed with respect to the absolute coordinate system. In other words, the rotation matrix corresponding to the X-axis is used to rotate the y-axis in the horizontal plane, and the rotation matrix corresponding to the Y-axis is used to rotate the x-axis in the horizontal plane. The conventional method of directional measurement is explained in further detail below using specific equations. An observation coordinate system, which corresponds to an x-axis, a y-axis, and a z-axis, is a coordinate system obtained by rotating an absolute coordinate system, which corresponds to an X-axis, a Y-axis, and a Z-axis, around the Z-axis by angle θ (azimuth), around the Y-axis by angle β counterclockwise, and around X-axis by angle α counterclockwise. The x-axis is an observation axis. A rotation matrix corresponding to a rotation around the Z-axis is assumed to be Zr, a rotation matrix corresponding to a rotation around the Y-axis is assumed to be Yr, and a rotation matrix corresponding to a rotation around the X-axis is assumed to be Xr.

Geomagnetic direction vectors (x_{H}, y_{H}, z_{H}) in the observation coordinate system can be expressed in a form obtained by converting geomagnetic direction vectors (X, Y, Z) in the absolute coordinate system using inverse matrixes of the rotation matrixes Zr, Yr, and Xr. If output values of the azimuth θ in the horizontal plane in the directions of the axes are taken as (xₕ, yₕ, zₕ), the geomagnetic direction vectors (x_{H}, y_{H}, z_{H}) in the observation coordinate system can be expressed by the following equation (1) using a product of the Zr rotation matrix and the geomagnetic direction vectors in the absolute coordinate system.

$$( \begin{matrix}{x}_{H} \\ {y}_{H} \\ {z}_{H}\end{matrix} ) = {Yr}^{- 1} {Xr}^{- 1} {Zr}^{- 1} ( \begin{matrix}X \\ Y \\ Z\end{matrix} ) = {Yr}^{- 1} {Xr}^{- 1} ( \begin{matrix}{x}_{h} \\ {y}_{h} \\ {z}_{h}\end{matrix} ) \qquad ( 1 )$$

By transforming the equation (1) to the following equation (2), the output values (xₕ, yₕ, zₕ) in the directions of the axes with respect to the azimuth θ in the horizontal plane can be converted to an equation using the geomagnetic direction vectors (x_{H}, y_{H}, z_{H}) in the observation coordinate system. In the equation (2), the reason that the sign α is reversed is because the output value of a tilt angle and the direction of rotation are reversed to each other since the counterclockwise rotation matrix is set as a reference.

$$( \begin{matrix}{x}_{h} \\ {y}_{h} \\ {z}_{h}\end{matrix} ) = XrYr \\ ( \begin{matrix}{x}_{H} \\ {y}_{H} \\ {z}_{H}\end{matrix} ) = [ \begin{matrix}1 & 0 & 0 \\ 0 & cos α & - sin α \\ 0 & sin α & cos α\end{matrix} ] \times [ \begin{matrix}cos β & 0 & - sin β \\ 0 & 1 & 0 \\ sin β & 0 & cos β\end{matrix} ] \times \\ ( \begin{matrix}{x}_{H} \\ {y}_{H} \\ {z}_{H}\end{matrix} ) = ( \begin{matrix}{x}_{H} cos β - {z}_{H} sin β \\ - {x}_{H} sin αsin β + {y}_{H} cos α - {z}_{H} sin αcos β \\ {x}_{H} cos α sin β + {y}_{H} sin α + {z}_{H} cos α cos β\end{matrix} ) \qquad ( 2 )$$

From the equation (2), it is possible to obtain the output values (xₕ, yₕ, zₕ) in the directions of the axes indicated when the observation coordinate system is converted to the horizontal direction. If the output values in the horizontal direction are obtained, the azimuth θ can be obtained from conditional branching according to the following equation (3) and sings xₕ and yₕ.

$$θ = arctan ( \frac{{y}_{h}}{{x}_{h}} ) \qquad ( 3 )$$

Japanese Patent No. 3008813 (see page 10, FIG. 5) discloses a directional measuring device that calculates a true direction by correcting a declination of a magnetic direction. Generally, there is a slight difference between the true north, which is the north on the map, and the magnetic north, which is the direction towards which the needle of a magnetic compass points. Because of the geographical location of Japan, in Japan, the needle of the magnetic compass always points a little westward with respect to the true north. The directional measuring device disclosed employs a method to correct the magnetic direction based on the difference between the direction towards which the needle of the magnetic compass points and the true north.

In the conventional technology, however, when the body is in tilted posture, the azimuth of the body can not be obtained precisely, and, the ambiguity in the calculation of the azimuth increases as the tilt becomes larger. Such problem arises because of the fact that, when there is a tilt, the rotational transformation of the x-axis and the y-axis does not yield proper results. In other words, when there is a tilt, the reverse rotation of the x-axis and the y-axis around the X-axis by the roll angle and the reverse rotation of the x-axis and the y-axis around the Y-axis by the pitch angle do not yield proper result. The reason is that the tilt angles (pitch angle and roll angle), which are angles between the x-axis or the y-axis and the horizontal plane, cannot be used for the rotational transformation as they are.

When the y-axis is reversely rotated the roll angle around the X-axis to make it horizontal, the y-axis is shifted to the horizontal plane, but the x-axis is also shifted following the shift of the y-axis. Consequently, the tilt angle between the x-axis and the horizontal plane does not match the pitch angle, that is, a deviation occurs. Therefore, even if the x-axis is reversely rotated the pitch angle around the Y-axis, the x-axis cannot be shifted to the horizontal plane. The y-axis having already shifted to the horizontal plane also shifts from the horizontal plane through the rotation around the X-axis to cause the y-axis to deviate from the horizontal plane. Thus, in the conventional technology, the geomagnetic vectors are not returned to the horizontal plane depending on the tilt angles, resulting in erroneous calculation of the azimuth including the error accordingly.

In the conventional technology, rotation by the angle θ around the Z-axis is performed before rotations round the X-axis and the Y-axis; therefore, the azimuth of the observation axis (x-axis) in the observation coordinate system sometimes deviates from when the x-axis is made to rotate in the horizontal plane. If the azimuth deviates in this manner, the geomagnetic vector does not match the horizontal plane depending on the roll angle αg and the pitch angle βg, resulting in an erroneous azimuth.

On the other hand, it is possible to calculate an azimuth by rotating the tilt angle around the x-axis, the y-axis, and the z-axis forming the observation coordinate system. However, the x-axis, y-axis, and z-axis are difficult to be calculated because the factors involved in the rotational transformation become complex, and the azimuth is difficult to be calculated.

### SUMMARY OF THE INVENTION

It is an object of the present invention to solve at least the problems in the conventional technology.

A directional measuring device according to an aspect of the present invention measures a direction of a body of the directional measuring device in a three-dimensional space including an X-axis indicating magnetic north on a horizontal plane, a Y-axis orthogonal to the X-axis in the horizontal plane, and a Z-axis orthogonal to the horizontal plane, assuming that the body points towards an x-axis. The directional measuring device includes a tilt angle detector that detects an x-axis tilt angle that is an angle between the x-axis and the horizontal plane and a y-axis tilt angle that is an angle between a y-axis, which is orthogonal to the x-axis, and the horizontal plane; a converter that rotates, based on the x-axis tilt angle and the y-axis tilt angle, the x-axis and the y-axis to obtain a rotated-x-axis and a rotated-y-axis that are in the horizontal plane; a primary azimuth calculator that calculates a primary azimuth that is an angle between the X-axis and the rotated-x-axis; and an azimuth error angle extracting unit that extracts, based on the x-axis tilt angle, the y-axis tilt angle, and the primary azimuth, an azimuth error angle included in the primary azimuth due to rotation by the converter.

A directional measuring method according to another aspect of the present invention is a method of measuring a direction of a body of the directional measuring device in a three-dimensional space including an X-axis indicating magnetic north on a horizontal plane, a Y-axis orthogonal to the X-axis in the horizontal plane, and a Z-axis orthogonal to the horizontal plane, assuming that the body points towards an x-axis. The method includes detecting an x-axis tilt angle that is an angle between the x-axis and the horizontal plane and a y-axis tilt angle that is an angle between a y-axis, which is orthogonal to the x-axis, and the horizontal plane; rotating, based on the x-axis tilt angle and the y-axis tilt angle, the x-axis and the y-axis to obtain a rotated-x-axis and a rotated-y-axis that are in the horizontal plane; calculating a primary azimuth that is an angle between the X-axis and the rotated-x-axis; and extracting, based on the x-axis tilt angle, the y-axis tilt angle, and the primary azimuth, an azimuth error angle included in the primary azimuth due to rotation by the converter.

The computer program according to still another aspect of the present invention realizes the method according to the present invention on a computer.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of a hardware configuration of a directional measuring device according to an embodiment of the present invention;

FIG. 2 is a diagram of an absolute coordinate system in which the directional measuring device is disposed;

FIG. 3 is a block diagram of a functional configuration of the directional measuring device;

FIG. 4 is a diagram to explain contents stored in an azimuth error angle parameter storage unit;

FIG. 5 is a diagram to explain a relation among a primary azimuth, an azimuth error angle, a secondary azimuth, an X-axis, an x-axis, and the direction of the true north;

FIG. 6 is a graph of a principle for calculation of the secondary azimuth according to the embodiment (part 1);

FIG. 7 is a graph of a principle for calculation of the secondary azimuth according to the embodiment (part 2);

FIG. 8 is a flowchart of a process procedure for calculating a directional (hereinafter, “directional calculation procedure”) (part 1);

FIG. 9 is a flowchart of a process procedure for calculating a directional (hereinafter, “directional calculation procedure”) (part 2); and

FIG. 10 is a flowchart of the process procedure based on the conventional technology.

### DETAILED DESCRIPTION

Exemplary embodiments of a method and a device for measuring a directional and a computer program according to the present invention are explained in detail below with reference to the accompanying drawings. In the embodiments, a coordinate system formed with an X (alphabetic capital letter) axis that points towards the magnetic north on a horizontal plane, a Y (alphabetic capital letter) axis that is orthogonal to the X-axis and is in the horizontal plane, and a Z (alphabetic capital letter) axis that is orthogonal to the horizontal plane, is referred to as an absolute coordinate system. Further, a direction towards which the body of the directional measuring device points is referred to as an x (alphabetic small letter) axis, an axis that is orthogonal to the x-axis is referred to as a y (alphabetic small letter) axis, and an axis that is orthogonal to both the x-axis and the y-axis is referred to as a z (alphabetic small letter) axis. The x-axis corresponds to the X-axis, the y-axis to the Y-axis, and the z-axis to the Z-axis.

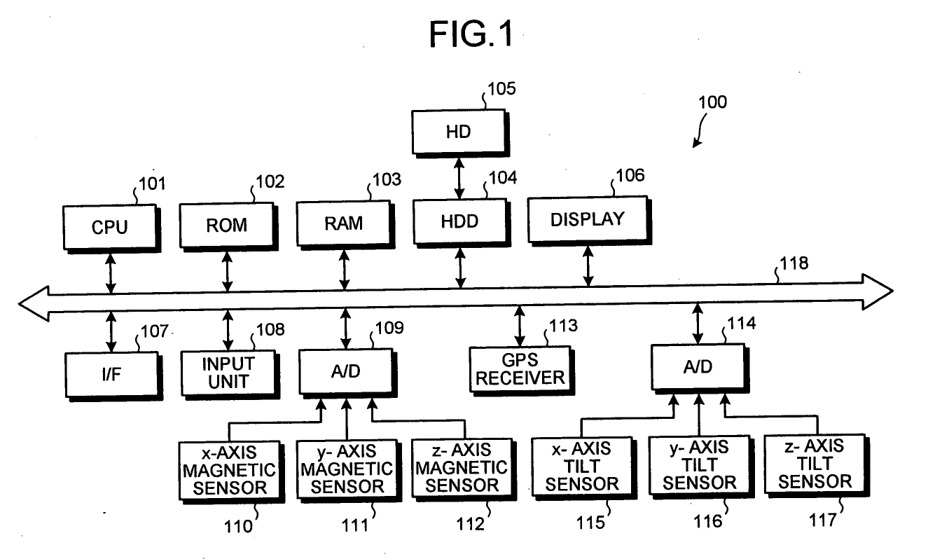

FIG. 1 is a block diagram of a hardware configuration of a directional measuring device according to an embodiment of the present invention. A directional measuring device 100 includes a central processing unit (CPU) 101, a read only memory (ROM) 102, a random access memory (RAM) 103, a hard disk drive (HDD) 104, a hard disk (HD) 105, a display 106, an interface (I/F) 107, an input key 108, and an analog-to-digital (A/D) converter 109. The directional measuring device 100 also includes an x-axis magnetic sensor 110, a y-axis magnetic sensor 111, a z-axis magnetic sensor 112, a global positioning system (GPS) receiver 113, an analog-to-digital (A/D) converter 114, an x-axis tilt sensor 115, a y-axis tilt sensor 116, and a z-axis tilt sensor 117. The components communicate with one another through a bus 118.

The CPU 101 controls the whole of the directional measuring device 100. The ROM 102 stores programs such as a boot program. The RAM 103 is used as a work area of the CPU 101. The HDD 104 controls read/write of data from/to the HD 105 under the control of the CPU 101. The HD 105 stores data.

The display 106 displays a cursor, icons, or tool boxes, and data such as documents, images, and functional information. The display 106 may be a cathode ray tube (CRT), a thin film transistor (TFT) liquid crystal display, or a plasma display.

The I/F 107 is connected to a network such as the Internet through a communication line. The directional measuring device 100 is connected, via the I/F 107, to another devices that are connected to the network. The I/F 107 interfaces between the network and the components, and controls input/output of data from/to an external device. The I/F 107 may be a modem or a local area network (LAN) adaptor. The input unit 108 includes keys for inputting characters, numbers, and instructions, and data entry is executed through the input unit 108. The input unit 108 may be a touch-panel type input pad or a ten-digit keypad.

The A/D converter 109 converts outputs of the x-axis magnetic sensor 110, the y-axis magnetic sensor 111, and the z-axis magnetic sensor 112 to digital signals. The x-axis magnetic sensor 110 is disposed on the x-axis and detects magnetism of the Earth in the x-axis direction. The magnetism here means the magnetic flux, the flux density, or the magnetic field. Likewise, the y-axis magnetic sensor 111 is disposed on the y-axis and detects magnetism in the y-axis direction and the z-axis magnetic sensor 112 is disposed on the z-axis and detects magnetism in the z-axis direction. The x-axis magnetic sensor 110, the y-axis magnetic sensor 111, and the z-axis magnetic sensor 112 output the detected results in the form of electrical signals to the A/D converter 109.

The GPS receiver 113 receives radio waves from GPS satellites. The geographical position of the GPS receiver 113 with respect to each GPS satellite is calculated from the data in the radio waves received from a corresponding one of the GPS satellites. This determination is possible in any locations on Earth. The determination is performed using Link 1 (L1) radio waves with a carrier wave of 1575.42 megahertz (MHz) and including a course acquisition (C/A) code and a navigation message. The C/A code has a bit rate of 1.023 mega-bits-per-second (Mbps) and a code length of 1023 bits=1 milliseconds (ms). The navigation message has a bit rate of 50 bits-per-second (bps), sub-frames of a code length 300 bits=6 seconds (s), and main frames of code length 1500 bits=30 s. Five sub-frames form one main frame and 25 main frames form one master frame. In other words, the GPS receiver 113 receives radio waves from the GPS satellites to output GPS positioning data.

The A/D converter 114 converts outputs of the x-axis tilt sensor 115, the y-axis tilt sensor 116, and the z-axis tilt sensor 117 to digital signals. Each of the x-axis tilt sensor 115, the y-axis tilt sensor 116, and the z-axis tilt sensor 117 detects a tilt amount of each axis, and includes an acceleration sensor. Output of biaxial and triaxial acceleration sensor has low sensitivity to another axis, and therefore, it is possible to obtain an angle between the horizontal plane and each axis. The x-axis tilt sensor 115 is disposed on the x-axis and outputs an amount of tilt of the x-axis direction with respect to the horizontal plane. The y-axis tilt sensor 116 is disposed on the y-axis and outputs an amount of tilt of the y-axis direction with respect to the horizontal plane. The z-axis tilt sensor 117 is disposed on the z-axis and outputs an amount of tilt of the z-axis direction with respect to the horizontal plane.

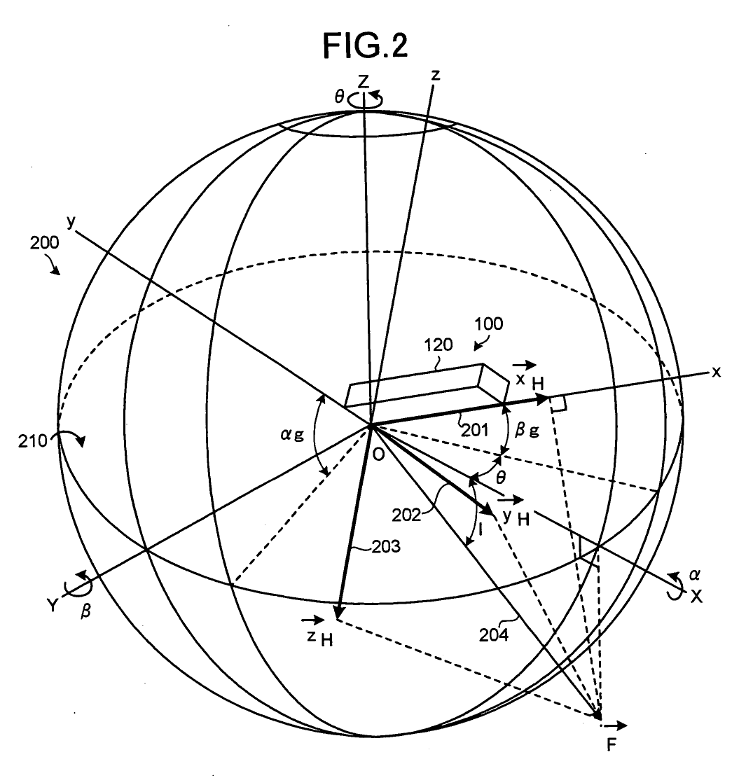

FIG. 2 is a diagram of an absolute coordinate system in which the directional measuring device 100 is disposed. A three-dimensional space (sphere) 200 formed with the X-axis, the Y-axis, and the Z-axis constitutes the absolute coordinate system. The body 120 of the directional measuring device 100 is positioned at the origin 0. A direction that is parallel to the long side of the body 120 corresponds to the x-axis. An angle between the x-axis, when it is projected on a horizontal plane 210, and the X-axis is an azimuth θ. Further, an angle (x-axis tilt angle) between the horizontal plane 210 and the x-axis is referred to as pitch angle βg, and is an angle when the body 120 is rotated around the Y-axis to be shifted to the horizontal plane 210. Furthermore, an angle (y-axis tilt angle) between the horizontal plane 210 and the y-axis is referred to as roll angle αg, and is an angle when the body 120 is rotated around the X-axis to be shifted to the horizontal plane 210.

A vector 201 represents a geomagnetic vector in the x-axis direction detected by the x-axis magnetic sensor 110, a vector 202 represents a geomagnetic vector in the y-axis direction detected by the y-axis magnetic sensor 111, and a vector 203 represents a geomagnetic vector in the z-axis direction detected by the z-axis magnetic sensor 112. The length of the vectors 201 to 203 represents a geomagnetic force in the respective directions.

A vector 204 is obtained by vector addition of the vectors 201 to 203. An angle between the vector 204 and the horizontal plane 210 is a dip I at the present position of the body 120. Therefore, coordinates of the vector 204 in the absolute coordinate system can be obtained from:

(X, Y, Z)=(Sh·cos I, 0, Sh·sin I),

where Sh is an output value indicating the magnitude of the geomagnetic vector (total geomagnetic force F). A relation between each of the vectors 201 to 204 and each of the relative geomagnetic forces is described below:

$$\begin{matrix}\vert {S}_{h} \vert = \sqrt{{{x}^{->}}_{H}^{2} + {{y}^{->}}_{H}^{2} + {{z}^{->}}_{H}^{2}} & ( 4 ) \\ {{x}^{->}}_{H}^{′} = \frac{{{x}^{->}}_{H}}{\vert {S}_{h} \vert} & ( 5 ) \\ {{y}^{->}}_{H}^{′} = \frac{{{y}^{->}}_{H}}{\vert {S}_{h} \vert} & ( 6 ) \\ {{z}^{->}}_{H}^{′} = \frac{{{z}^{->}}_{H}}{\vert {S}_{h} \vert} & ( 7 )\end{matrix}$$

where

|Sₕ|: OUTPUT VALUE OF MAGNETIC SENSOR CORRESPONDING TO SYNTHESIZED GEOMAGNETIC FORCE F

\vec{x}′_{H}: VALUE OBTAINED BY NORMALIZING OUTPUT VALUE OF x-AXIS MAGNETIC SENSOR BY WHOLE OUTPUT VALUES

\vec{x}_{H}: OUTPUT VALUE OF x-AXIS MAGNETIC SENSOR

\vec{y}′_{H}: VALUE OBTAINED BY NORMALIZING OUTPUT VALUE OF y-AXIS MAGNETIC SENSOR BY WHOLE OUTPUT VALUES

\vec{y}_{H}: OUTPUT VALUE OF y-AXIS MAGNETIC SENSOR

\vec{z}′_{H}: VALUE OBTAINED BY NORMALIZING OUTPUT VALUE OF z-AXIS MAGNETIC SENSOR BY WHOLE OUTPUT VALUES

\vec{z}_{H}: OUTPUT VALUE OF z-AXIS MAGNETIC SENSOR

The pitch angle βg (x-axis tilt angle) and the roll angle αg (y-axis tilt angle) are detected by the x-axis tilt sensor 115 and the y-axis tilt sensor 116. A relation between the vectors detected by the x-axis tilt sensor 115, the y-axis tilt sensor 116, and the z-axis tilt sensor 117 and their relevant tilt amounts is described below:

$$\begin{matrix}{α}_{g} = {sin}^{- 1} \frac{{{y}^{->}}_{g}}{{W}_{g}} & ( 8 ) \\ {β}_{g} = {sin}^{- 1} \frac{{{x}^{->}}_{g}}{{W}_{g}} & ( 9 ) \\ {W}_{g} = \sqrt{{{x}^{->}}_{g}^{2} + {{y}^{->}}_{g}^{2} + {{z}^{->}}_{g}^{2}} & ( 10 )\end{matrix}$$

where

\vec{x}_{g}: OUTPUT VALUE OF x-AXIS ACCELERATION SENSOR

\vec{y}_{g}: OUTPUT VALUE OF y-AXIS ACCELERATION SENSOR

\vec{z}_{g}: OUTPUT VALUE OF z-AXIS ACCELERATION SENSOR

W_{g}: TOTAL VALUE OF OUTPUTS OF ACCELERATION SENSORS CORRESPONDING TO GRAVITY ACCELERATION

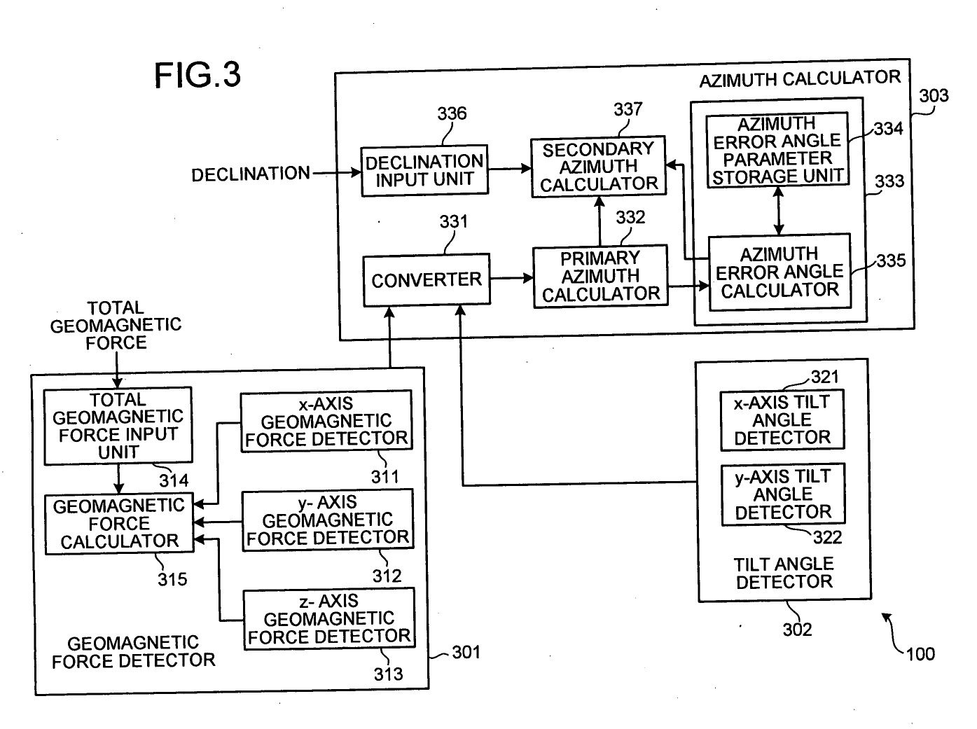

FIG. 3 is a block diagram of a functional configuration of the directional measuring device 100. The directional measuring device 100 includes a geomagnetic force detector 301, a tilt angle detector 302, and an azimuth calculator 303.

The geomagnetic force detector 301 includes an x-axis direction geomagnetic force detector 311 (hereinafter, “x-axis geomagnetic force detector 311”), a y-axis direction geomagnetic force detector 312 (hereinafter, “y-axis geomagnetic force detector 312”), a z-axis direction geomagnetic force detector 313 (hereinafter, “z-axis geomagnetic force detector 313”), a total geomagnetic force input unit 314, and a geomagnetic force calculator 315.

The x-axis geomagnetic force detector 311 detects a geomagnetic force in the x-axis direction. More specifically, the x-axis geomagnetic force detector 311 detects the geomagnetic force in the x-axis direction from the output of the x-axis magnetic sensor 110, and normalizes the geomagnetic force detected by an output value Sh of the total geomagnetic force F.

The y-axis geomagnetic force detector 312 detects a geomagnetic force in the y-axis direction. More specifically, the y-axis geomagnetic force detector 312 detects the geomagnetic force in the y-axis direction from the output of the y-axis magnetic sensor 111, and normalizes the geomagnetic force detected by an output value Sh of the total geomagnetic force F.

The z-axis geomagnetic force detector 313 detects a geomagnetic force in the z-axis direction. More specifically, the z-axis geomagnetic force detector 313 detects the geomagnetic force in the z-axis direction from the output of the z-axis magnetic sensor 112, and normalizes the geomagnetic force detected by an output value Sh of the total geomagnetic force F.

The total geomagnetic force input unit 314 inputs a total geomagnetic force at a present position of the body 120. More specifically, the information for the present position of the body 120 obtained from the GPS receiver 113 is transmitted to a server (not shown). The server identifies a latitude and a longitude of the present position of the body 120 from the received present position information and transmits the value Sh of the total geomagnetic force F corresponding to the latitude and the longitude to the directional measuring device 100. The directional measuring device 100 receives the value Sh of the total geomagnetic force F.

The geomagnetic force calculator 315 calculates a geomagnetic force in a direction of an axis (third axis) other than a first axis and a second axis based on the total geomagnetic force at the present position input by the total geomagnetic force input unit 314 and geomagnetic force detectors in two axes (the first axis and the second axis) of the geomagnetic force detector 301. The geomagnetic force detectors in two axes are selected from the x-axis geomagnetic force detector 311, the y-axis geomagnetic force detector 312, and the z-axis geomagnetic force detector 313.

More specifically, if the directional measuring device 100 includes only the x-axis magnetic sensor 110 and the y-axis magnetic sensor 111, a geomagnetic force in the z-axis direction can be calculated using the equation (4).

The tilt angle detector 302 includes an x-axis tilt angle detector 321 and a y-axis tilt angle detector 322. The x-axis tilt angle detector 321 detects the x-axis tilt angle, which is the pitch angle βg, between the horizontal plane 210 and the x-axis from the output of the x-axis tilt sensor 115. The y-axis tilt angle detector 322 detects the y-axis tilt angle, which is the roll angle αg, between the horizontal plane 210 and the y-axis from the output of the y-axis tilt sensor 116.

The azimuth calculator 303 includes a converter 331, a primary azimuth calculator 332, an azimuth error angle extracting unit 333, a declination input unit 336, and a secondary azimuth calculator 337. The converter 331 converts the x-axis and the y-axis so as to be in the horizontal plane using the x-axis tilt angle and the y-axis tilt angle detected by the tilt angle detector 302. More specifically, coordinate transformation is performed twice to the coordinates of the three-dimensional magnetic vectors 201 to 203 (see FIG. 2) indicating geomagnetic forces detected by the geomagnetic force detector 301, using the x-axis tilt angle and the y-axis tilt angle detected by the tilt angle detector 302 to calculate a magnetic vector of a horizontal magnetic field component.

The conversion process by the converter 331 is explained in further detail below with reference to specific equations. An observation coordinate system, which corresponds to the x-axis, the y-axis, and the z-axis, is a coordinate system obtained by rotating an absolute coordinate system, which corresponds to the X-axis, the Y-axis, and the Z-axis, around the Z-axis by angle θ (azimuth) counterclockwise, around the Y-axis by angle β counterclockwise, and around X-axis by angle α counterclockwise. The x-axis is an observation axis. A rotation matrix corresponding to a rotation around the Z-axis is assumed to be Zr, a rotation matrix corresponding to a rotation around the Y-axis is assumed to be Yr, and a rotation matrix corresponding to a rotation around the X-axis is assumed to be Xr.

Geomagnetic direction vectors (x_{H}, y_{H}, z_{H}) in the observation coordinate system can be expressed in a form obtained by converting geomagnetic direction vectors (X, Y, Z) in the absolute coordinate system using inverse matrixes of the rotation matrixes Zr, Yr, and Xr. If output values of the azimuth θ in the horizontal plane in the directions of the axes are taken as (xₕ, yₕ, zₕ), the geomagnetic direction vectors (x_{H}, y_{H}, z_{H}) in the observation coordinate system can be expressed by the following equation (11) using a product of the Zr rotation matrix and the geomagnetic direction vectors in the absolute coordinate system.

$$( \begin{matrix}{x}_{H} \\ {y}_{H} \\ {z}_{H}\end{matrix} ) = {Yr}^{- 1} {Xr}^{- 1} {Zr}^{- 1} ( \begin{matrix}X \\ Y \\ Z\end{matrix} ) = {Yr}^{- 1} {Xr}^{- 1} ( \begin{matrix}{x}_{h} \\ {y}_{h} \\ {z}_{h}\end{matrix} ) \qquad ( 11 )$$

By transforming the equation (11) to the following equation (12), the output values (xₕ, yₕ, zₕ) in the directions of the axes with respect to the azimuth θ in the horizontal plane can be converted to an equation using the geomagnetic direction vectors (x_{H}, y_{H}, z_{H}) in the observation coordinate system. In the equation (12), the reason that the sign α is reversed in the equation (12) is because the output value of a tilt angle and the direction of rotation are reversed to each other since the counterclockwise rotation matrix is set as a reference.

$$( \begin{matrix}{x}_{h} \\ {y}_{h} \\ {z}_{h}\end{matrix} ) XrYr ( \begin{matrix}{x}_{H} \\ {y}_{H} \\ {z}_{H}\end{matrix} ) = [ \begin{matrix}1 & 0 & 0 \\ 0 & cos α & - sin α \\ 0 & sin α & cos α\end{matrix} ] \times [ \begin{matrix}cos β & 0 & - sin β \\ 0 & 1 & 0 \\ sin β & 0 & cos β\end{matrix} ] \times \\ ( \begin{matrix}{x}_{H} \\ {y}_{H} \\ {z}_{H}\end{matrix} )$$

$$= \begin{matrix}( \begin{matrix}{x}_{H} cos β - {z}_{H} sin β \\ - {x}_{H} sin αsin β + {y}_{H} cos α - {z}_{H} sin αcos β \\ {x}_{H} cos α sin β + {y}_{H} sin α + {z}_{H} cos α cos β\end{matrix} ) & ( 12 )\end{matrix}$$

The primary azimuth calculator 332 calculates a primary azimuth θ1 that is an angle between the X-axis that indicates the magnetic north and the x-axis converted by the converter 331. Explanation is given using specific equations. From the equation (12), it is possible to obtain the output values (xₕ, yₕ, zₕ) in the directions of the axes when the observation coordinate system is converted to that in the horizontal direction. If the output values in the horizontal direction are obtained, the primary azimuth θ1 can be obtained from conditional branching according to the following equation (13) and the sings xₕ and yₕ.

$$θ 1 = arctan ( \frac{{y}_{h}}{{x}_{h}} ) \qquad ( 13 )$$

The azimuth error angle extracting unit 333 extracts an azimuth error angle Δθ included in the primary azimuth θ1 by the conversion performed by the converter 331 based on the x-axis tilt angle (pitch angle βg) and the y-axis tilt angle (roll angle αg) detected by the tilt angle detector 302 and the primary azimuth θ1 calculated by the primary azimuth calculator 332. More specifically, the azimuth error angle extracting unit 333 includes an azimuth error angle parameter storage unit 334 and an azimuth error angle calculator 335.

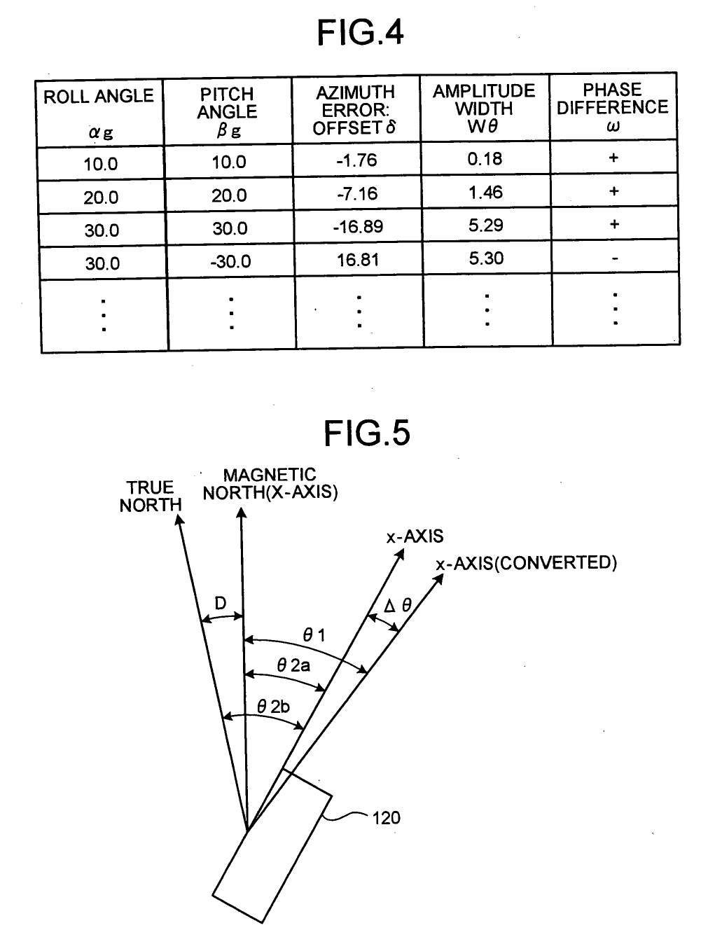

The azimuth error angle parameter storage unit 334 stores parameters required for calculation of the azimuth error angle Δθ. The contents stored in the azimuth error angle parameter storage unit 334 are explained below specifically. FIG. 4 is a diagram to explain the contents stored in the azimuth error angle parameter storage unit 334. The azimuth error angle parameter storage unit 334 stores an azimuth error: offset δ, an amplitude width Wθ, and a phase difference ω that are azimuth error angle parameters, in each combination of the roll angle αg and the pitch angle βg. The azimuth error: offset δ mentioned here is a predetermined value that is set based on directions and magnitudes of the tilt angles (roll angle αg and pitch angle βg) detected by the tilt angle detector 302.

The amplitude width Wθ represents an amplitude of a sine curve that is a variation of the azimuth error angle Δθ. The phase difference ω represents positive and negative characteristics of the sine curve that are variations of the azimuth error angle Δθ. The sine curve is explained later. The azimuth error angle parameter storage unit 334 realizes its functions by, for example, the ROM 102, the RAM 103, and the HD 105.

The azimuth error angle calculator 335 outputs an azimuth error angle Δθ included in the primary azimuth θ1 by the conversion performed by the converter 331 based on the tilt angles (roll angle αg and pitch angle βg) detected by the tilt angle detector 302 and the primary azimuth θ1 calculated by the primary azimuth calculator 332. More specifically, the azimuth error angle calculator 335 extracts the azimuth error: offset δ, the amplitude width Wθ, and the phase difference ω from the azimuth error angle parameter storage unit 334. The azimuth error angle calculator 335 calculates an azimuth error angle Δθ using the azimuth error angle parameters extracted. Explanation is given more specifically using equations. The azimuth error angle calculator 335 calculates an azimuth error angle Δθ by substituting the azimuth error angle parameters and the primary azimuth θ1 in the sine curve that becomes the valuations of the azimuth error angle Δθ of the following equation (14).

Δθ=δ+ω×Wθ×sin θ1 (14)

Note that the phase difference ω takes “+1” in the positive case and “−1” in the negative case.

The azimuth error: offset δ in the right side of the equation (14) is a first error angle with a predetermined amount based on directions and magnitudes of the tilt angles (roll angle αg and pitch angle βg) detected by the tilt angle detector 302, and ω×Wθ×sin θ1 is a sine curve that represents variation characteristics of the azimuth error angle Δθ. The value of the sine curve becomes a second error angle that represents variations by which the azimuth error: offset δ that is the first error angle varies.

The declination input unit 336 inputs a declination D that is an angle between the magnetic north at the present position of the body and the true north. For the declination at the present position thereof in Japan, the results of measurement of magnetism are disclosed as a table by the Geographical Survey Institute, and therefore, the declination D at any region is obtained by the table. More specifically, the information for the present position of the body 120 obtained from the GPS receiver 113 is transmitted to a server (not shown). The server identifies a latitude and a longitude of the present position of the body 120 from the present position information received and transmits declination data corresponding to the latitude and the longitude to the directional measuring device 100. The directional measuring device 100 receives the declination data. The declination input unit 336 can obtain the declination by using a declination calculating method of approximating it by a quadratic equation. More specifically, the declination input unit 336 can input declination D by calculating it using the following equation (15) to equation (17).

D_{2000.0}=7°37.142′+21.622′Δφ−7.672′Δλ+0.442′Δφ²−0.32′ΔφΔλ+0.675′Δλ² (15)

Δφ=(LATITUDE φ AT MEASURED POSITION)−37 (16)

Δλ=(LONGITUDE λ AT MEASURED POSITION)−138 (17)

The secondary azimuth calculator 337 calculates a secondary azimuth θ2 that represents a direction of the body 120 based on the primary azimuth θ1 calculated by the primary azimuth calculator 332 and the azimuth error angle Δθ calculated by the azimuth error angle calculator 335. More specifically, the secondary azimuth calculator 337 calculates an azimuth θ2a based on the magnetic north as a reference using the following equation (18).

θ2a=θ1−Δθ (18)

The secondary azimuth calculator 337 further calculates an azimuth θ2b based on the true north as a reference using the following equation (19), based on the declination D input by the declination input unit 336.

θ2b=θ1−Δθ−D (19)

Shown in FIG. 5 is a relation among the primary azimuth θ1, the azimuth error angle Δθ, the secondary azimuths θ2a and θ2b, the X-axis that is the magnetic north, the x-axis that is a direction towards which the body 120 points, and the direction of the true north. The geomagnetic force detector 301, the tilt angle detector 302, and the azimuth calculator 303 perform their functions when the CPU 101 executes programs stored in the ROM 102, the RAM 103, and the HD 105 as shown in FIG. 1.

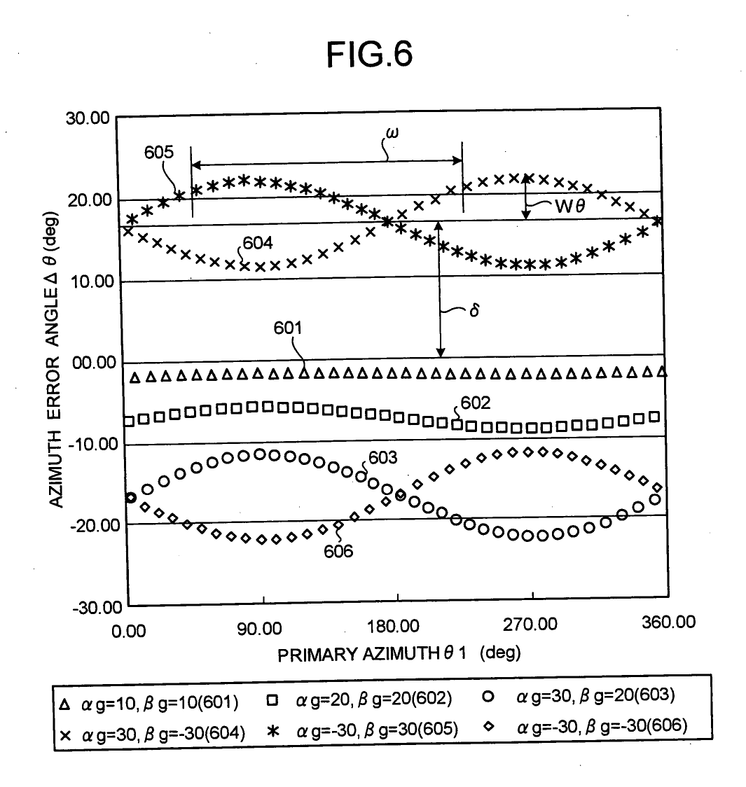

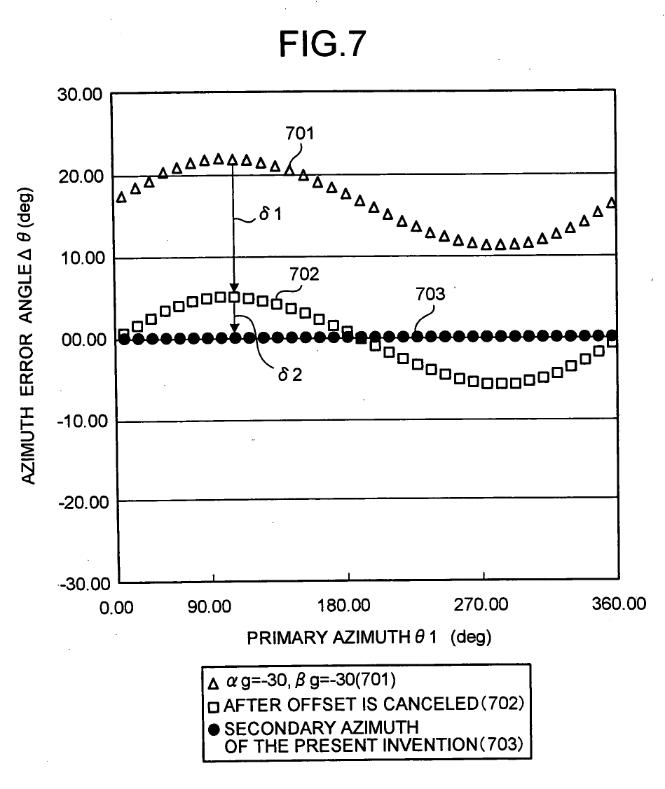

The calculation principle of a secondary azimuth according to the embodiment of the present invention is explained below. FIG. 6 and FIG. 7 are graphs that represent the calculation principle of the secondary azimuth, and represent a relation between the primary azimuth θ1 and the azimuth error angle Δθ. In FIG. 6 and FIG. 7, the horizontal-axis represents the primary azimuth θ1, and the vertical-axis represents the azimuth error angle Δθ.

As shown in FIG. 6, variable functions 601 to 606 that represent a relation between the primary azimuth θ1 and the azimuth error angle Δθ are plotted in each combination of the roll angle αg and the pitch angle βg. The variable functions 601 to 606 plotted represent an error amount included in the primary azimuth θ1 by the conversion performed by the converter 331 when the secondary azimuth that is the true azimuth is set to azimuth error angle Δθ=0.

The variable function 604 as shown in FIG. 6 is explained below as an example. The variable function 604 is a characteristic curve indicating an azimuth error angle Δθ when the roll angle αg is 30 degrees and the pitch angle βg is −30 degrees. It is understood from this sine curve that the azimuth error: offset δ is 16.8 degrees, the amplitude width Wθ is 5.3 degrees, and the phase difference ω has a negative characteristic. In the phase difference ω, the case where the variable function 604 follows the sine curve is expressed as a positive (+) phase, and the sine curve when the phase leads by 180 degrees is expressed as a negative (−) phase.

A method of calculating the secondary azimuth θ2 is explained below. As shown in FIG. 7, a variable function 701 is a sine curve when the roll angle αg is −30 degrees and the pitch angle βg is −30 degrees. A first error angle δ1 that is an azimuth error: offset δ of the variable function 701 is canceled by the first term in the right side of the equation (14) to be made to a variable function 702. In the variable function 702, a second error angle δ2 (δ2=ω×Wθ×sin θ1) that is variations of the first error angle δ1 is canceled by the second term in the right side of the equation (14) to convert the variable function 702 to a variable function 703. Since the variable function 703 expresses the azimuth error angle Δθ=0, the azimuth error angle Δθ has been erased from the primary azimuth θ1.

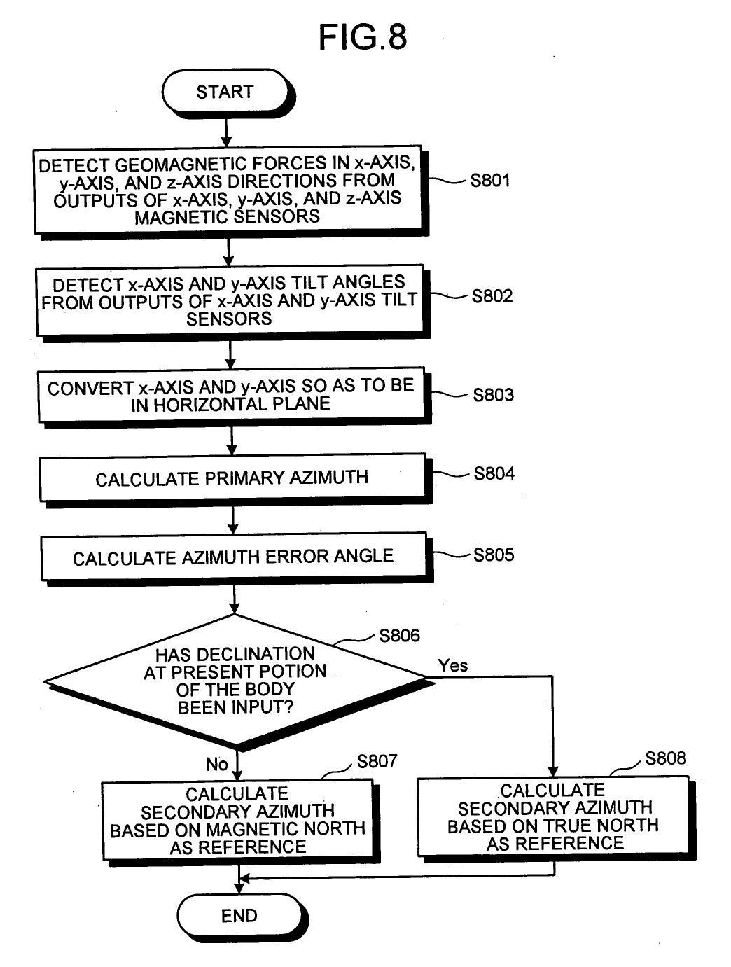

FIG. 8 is a flowchart of a directional calculation procedure (part 1) according to the embodiment of the present invention. As shown in the flowchart, geomagnetic forces along the x-axis, the y-axis, and the z-axis are detected from outputs of the x-axis, y-axis, and z-axis magnetic sensors 110 to 112 (step S801). Further, an x-axis tilt angle (pitch angle βg) and a y-axis tilt angle (roll angle αg) are detected from outputs of the x-axis and y-axis tilt sensors 115 and 116 (step S802).

Next, by using the equation (12), the x-axis and the y-axis are converted so as to be in the horizontal plane based on the geomagnetic forces along the x-axis, the y-axis, and the z-axis, and the x-axis tilt angle (pitch angle βg) and the y-axis tilt angle (roll angle αg) (step S803). By using the equation (13), an angle, i.e., a primary azimuth θ1 that is an angle between the x-axis converted and the X-axis that indicates the magnetic north is calculated (step S804).

Next, azimuth error angle parameters (azimuth error: offset δ, amplitude width Wθ, and phase difference ω) of the x-axis tilt angle (pitch angle βg) and the y-axis tilt angle (roll angle αg) detected at step S802 are extracted to calculate an azimuth error angle Δθ of the primary azimuth calculated at step S804 (step S805). If the declination D at the present position of the body has not been input (step S806: No), a secondary azimuth θ2a based on the magnetic north as a reference is calculated (step S807) by using the equation (18). On the other hand, if the declination D at the present position has been input (step S806: Yes), a secondary azimuth based on the true north as a reference is calculated (step S808).

In the embodiment, the azimuth error angle Δθ included in the primary azimuth θ1 by the conversion performed by the converter 331 is calculated in each combination of the roll angle αg and the pitch angle βg of the body 120, which allows the azimuth error angle Δθ to be 0. Thus, it is possible to calculate the true azimuth θ2 with high precision.

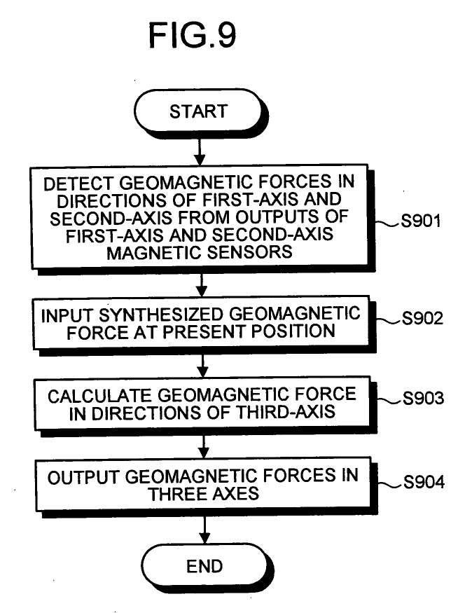

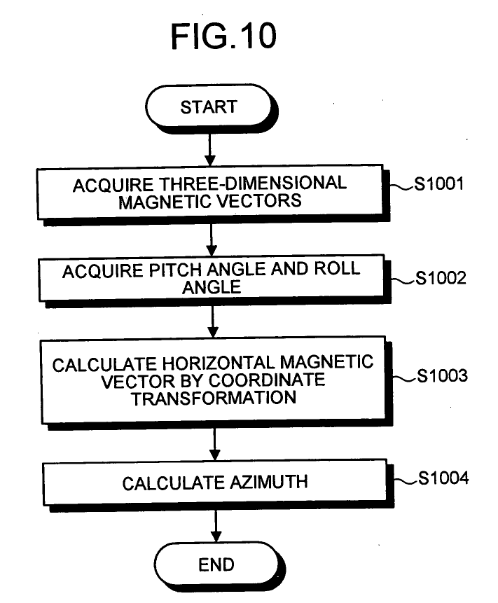

FIG. 9 is a flowchart of the directional calculation procedure (part 2) according to the embodiment. The process procedure is used to calculate a secondary azimuth θ2 by a so-called biaxial magnetic sensor. As one example here, the x-axis is set as a first axis, the y-axis as a second axis, and the z-axis as a third axis. The magnetic sensor is provided on the first and second axes, and no magnetic sensor is provided on the third axis.

As shown in FIG. 9, at first, geomagnetic forces in the directions of the first axis and the second axis are detected from outputs of the first axis and second axis magnetic sensors (step S901). A total geomagnetic force at the present position is input (step S902). The total geomagnetic force F in each region in Japan can be approximated by the following equation (20) to equation (22).

F_{2000.0}=47505.3881+567.453Δφ−294.499Δλ−0.225Δφ²−2.975ΔφΔλ+1.291Δλ² (20)

Δφ=(LATITUDE φ AT MEASURED POSITION)−37 (21)

Δλ=(LONGITUDE λ AT MEASURED POSITION)−138 (22)

Next, a geomagnetic force in the direction of the third axis is calculated (step S903). The geomagnetic force in the third axis direction can be calculated at this step by the following equation (23) to equation (25).

$$\begin{matrix}{{x}^{->}}_{H}^{′} = \frac{{{x}^{->}}_{H}}{\vert {S}_{h}^{′} \vert} & ( 23 ) \\ {{y}^{->}}_{H}^{′} = \frac{{{y}^{->}}_{H}}{\vert {S}_{h}^{′} \vert} & ( 24 ) \\ {{z}^{->}}_{H}^{′} = \sqrt{1 - ( {{x}^{->}}_{H}^{′2} + {{y}^{->}}_{H}^{′2} )} & ( 25 )\end{matrix}$$

where

\vec{x}′_{H}, \vec{y}′_{H}: VALUES OBTAINED BY NORMALIZING OUTPUT VALUES OF x-AXIS AND y-AXIS MAGNETIC SENSORS BY S′h

\vec{x}_{H}, \vec{y}_{H}: OUTPUT VALUES OF x-AXIS AND y-AXIS MAGNETIC SENSORS

|S′ₕ|: OUTPUT VALUE OF MAGNETIC SENSOR CORRESPONDING TO TOTAL GEOMAGNETIC FORCE F.

The calculated geomagnetic force of the third axis is output (step S904). The steps thereafter are the same as those in FIG. 8, and therefore, explanation thereof is omitted. According to this procedure, the biaxial magnetic sensor is capable of measuring directions with high precision in the same manner as that of the triaxial magnetic sensor. Furthermore, it is possible to reduce the number of components, minimize, and reduce its weight, thus providing the directional measuring device 100 at a low cost.

In the embodiment, the azimuth error angle calculator 335 calculates and outputs the azimuth error angle Δθ. However, the azimuth error angle parameter storage unit 334 may be configured to previously store the azimuth error angle Δθ calculated for each roll angle αg and pitch angle βg, and an azimuth error angle Δθ corresponding to the present roll angle αg and pitch angle βg of the body 120 may be extracted from the azimuth error angle parameter storage unit 334.

In the embodiment, the method of correction that is commonly used in Japan, i.e., a method that uses the primary azimuth θ1, the azimuth error angle Δθ, and the declination D, has been explained, but it is not limited to this method. If a latitude φ and a longitude λ of a measured position are given in any region all over the world, it is possible to obtain declination D and total geomagnetic force F. Therefore, data for the declination D and the total geomagnetic force F are stored in advance as database, which allows acquisition of a precise direction in any region all over the world.

Furthermore, the calculation equation is not limited to that in the above embodiment, and therefore, the users can use any of methods as follows to acquire the calculation equation. The methods include a method of directly inputting the declination D by the user to perform calculation, and a method of automatically acquiring position information through communications, radio waves, or GPS to calculate it with a measurement equation. The methods also include a method of automatically acquiring it through access to a server, on a network, including a table in which position information correlates with declination D, total geomagnetic force F, and dip.

Furthermore, in the embodiment, the explanation is given based on an integrated circuit (IC) module, but it is not limited to this. Therefore, the directional measuring device 100 including a display unit and a power source and operating as a single unit may be used. Alternatively, the directional measuring device 100 may be incorporated in any of electronic devices. Further, all the hardware components as shown in FIG. 1 are not necessarily integrated into one unit, but, for example, the measurement may be performed by a CPU or a microcomputer in the device including the directional measuring device 100.

In the embodiment, data for the declination D and the total geomagnetic force F can be acquired from the latitude and the longitude of the present position of the body. Therefore, the user can freely select or combine the data. Even if the user does not select the data, initial values of the data can be stored in the directional measuring device 100 to measure a direction using them.

Furthermore, in the embodiment, a total output value Wg has been calculated with a square root of a squared sum of the output values of the acceleration sensors in the respective axes by using the triaxial acceleration sensor as the tilt sensors 115 to 117 in the three axes. However, since the gravity acceleration g corresponds to the total output value Wg, the total output value may be used. In this case, by calculating the total output value Wg, an acceleration in the measurement is obtained. Furthermore, by comparing the acceleration with the known gravity acceleration, information as to whether any acceleration factor other than the gravity acts is also obtained, and therefore, correction may be performed using the information. Moreover, the tilt sensors 115 to 117 may be configured not with three axes but with two axes. In this case, by inputting the total output value Wg corresponding to the gravity acceleration, a tilt angle of the respective axes can be calculated.

It is assumed that the directional measuring device 100 is used and held by the users in various ways, and it is quite possible that the directional measuring device 100, i.e., the magnetic sensors 110 to 112 may be used even when they are tilted with respect to the horizontal plane 210. In such a case also, it is possible to calculate the secondary azimuth θ2 with high precision even in a state where the body 120 is tilted. Particularly, the present invention is effective in cell phones, portable information terminals such as PDA, and wrist watches. Furthermore, the algorism used in the directional measuring device 100 is simple to make it easy to be incorporated in various devices.

The direction measuring method according to the embodiment of the present invention is realized by executing the previously prepared program on a computer such as a personal computer and a work station. The program is recorded in a computer-readable recording medium such as a hard disk, a flexible disk, a compact disk-read only memory (CD-ROM), a magneto-optic disk (MO), and a digital versatile disk (DVD). The program is then executed by being read out from the recording medium by the computer. Furthermore, the program may be a transmission medium capable of being distributed through a network such as the Internet. According to the directional measuring device, the directional measuring method, and the directional measuring program according to the present invention, even if a value of an azimuth error angle included in a primary azimuth varies caused by any combination of a roll angle and a pitch angle of the body, an azimuth error angle corresponding to the roll angle and the pitch angle can be extracted at each primary azimuth by converting the x-axis that is a direction towards which the body points to an axis in the horizontal plane. Thus, a secondary azimuth that is a true azimuth can be calculated by the primary azimuth and the azimuth error angle extracted. Therefore, it is possible to measure a direction with lesser efforts and high precision by performing a simple computation even if the body is in a tilted posture.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A directional measuring device that measures a direction of a body of the directional measuring device in a three-dimensional space including an X-axis indicating magnetic north on a horizontal plane, a Y-axis orthogonal to the X-axis in the horizontal plane, and a Z-axis orthogonal to the horizontal plane, assuming that the body points towards an x-axis, comprising:
a tilt angle detector that detects an x-axis tilt angle that is an angle between the x-axis and the horizontal plane and a y-axis tilt angle that is an angle between a y-axis, which is orthogonal to the x-axis, and the horizontal plane;
a converter that rotates, based on the x-axis tilt angle and the y-axis tilt angle, the x-axis and the y-axis to obtain a rotated-x-axis and a rotated-y-axis that are in the horizontal plane;
a primary azimuth calculator that calculates a primary azimuth that is an angle between the X-axis and the rotated-x-axis; and
an azimuth error angle extracting unit that extracts, based on the x-axis tilt angle, the y-axis tilt angle, and the primary azimuth, an azimuth error angle included in the primary azimuth due to rotation by the converter.

2. The directional measuring device according to claim 1, wherein the azimuth error angle includes a first error angle by a predetermined amount based on a direction and a magnitude of each of the x-axis tilt angle and the y-axis tilt angle.

3. The directional measuring device according to claim 2, wherein the azimuth error angle includes a second error angle that represents a variation by which the first error angle varies according to a value of the primary azimuth.

4. The directional measuring device according to claim 1, further comprising:
a secondary azimuth calculator that calculates, based on the primary azimuth and the azimuth error angle, a secondary azimuth that represents a direction of the body.

5. The directional measuring device according to claim 4, further comprising:
a declination input unit that receives a declination at a present position of the body, wherein
the second azimuth calculator calculates the second azimuth from the declination.

6. The directional measuring device according to claim 1, further comprising:
a first-axis geomagnetic force detector that detects a geomagnetic force along a first axis from among the x-axis, the y-axis, and the z-axis, which is orthogonal to both the x-axis and the y-axis;
a second-axis geomagnetic force detector that detects a geomagnetic force along a second axis other than the first axis from among the x-axis, the y-axis, and the z-axis;
a total geomagnetic force input unit that receives a total geomagnetic force at a present position of the body, wherein the total geomagnetic force is a vector addition of geomagnetic forces along the X-axis, the Y-axis, and the Z-axis; and
a geomagnetic force calculator that calculates a geomagnetic force along a third axis other than the first axis and the second axis, from among the x-axis, the y-axis, and the z-axis based on the total geomagnetic force and the geomagnetic forces along the first axis and the second axis, wherein
the primary azimuth calculator calculates the primary azimuth based on the geomagnetic forces along the first axis to the third axis.

7. A directional measuring method of measuring a direction of a body of the directional measuring device in a three-dimensional space including an X-axis indicating magnetic north on a horizontal plane, a Y-axis orthogonal to the X-axis in the horizontal plane, and a Z-axis orthogonal to the horizontal plane, assuming that the body points towards an x-axis, comprising:
detecting an x-axis tilt angle that is an angle between the x-axis and the horizontal plane and a y-axis tilt angle that is an angle between a y-axis, which is orthogonal to the x-axis, and the horizontal plane;
rotating, based on the x-axis tilt angle and the y-axis tilt angle, the x-axis and the y-axis to obtain a rotated-x-axis and a rotated-y-axis that are in the horizontal plane;
calculating a primary azimuth that is an angle between the X-axis and the rotated-x-axis; and
extracting, based on the x-axis tilt angle, the y-axis tilt angle, and the primary azimuth, an azimuth error angle included in the primary azimuth due to rotation by the converter.

8. The directional measuring method according to claim 7, wherein the azimuth error angle includes a first error angle by a predetermined amount based on a direction and a magnitude of each of the x-axis tilt angle and the y-axis tilt angle.

9. The directional measuring method according to claim 8, wherein the azimuth error angle includes a second error angle that represents a variation by which the first error angle varies according to a value of the primary azimuth.

10. The directional measuring method according to claim 7, further comprising:
calculating, based on the primary azimuth and the azimuth error angle, a secondary azimuth that represents a direction of the body.

11. The directional measuring method according to claim 10, further comprising receiving a declination at a present position of the body, wherein
the calculating the secondary azimuth includes calculating the second azimuth from on the declination.

12. The directional measuring method according to claim 7, further comprising:
detecting a geomagnetic force along a first axis from among the x-axis, the y-axis, and the z-axis, which is orthogonal to both the x-axis and the y-axis;
detecting a geomagnetic force along a second axis other than the first axis from among the x-axis, the y-axis, and the z-axis;
receiving a total geomagnetic force at a present position of the body, wherein the total geomagnetic force is a vector addition of geomagnetic forces along the X-axis, the Y-axis, and the Z-axis; and
calculating a geomagnetic force along a third axis other than the first axis and the second axis, from among the x-axis, the y-axis, and the z-axis based on the total geomagnetic force and the geomagnetic forces along the first axis and the second axis, wherein
the calculating the primary azimuth includes calculating the primary azimuth based on the geomagnetic forces along the first axis to the third axis.

13. A computer program that realizes on a computer a directional measuring method of measuring a direction of a body of the directional measuring device in a three-dimensional space including an X-axis indicating magnetic north on a horizontal plane, a Y-axis orthogonal to the X-axis in the horizontal plane, and a Z-axis orthogonal to the horizontal plane, assuming that the body points towards an x-axis, the computer program making the computer execute:
detecting an x-axis tilt angle that is an angle between the x-axis and the horizontal plane and a y-axis tilt angle that is an angle between a y-axis, which is orthogonal to the x-axis, and the horizontal plane;
rotating, based on the x-axis tilt angle and the y-axis tilt angle, the x-axis and the y-axis to obtain a rotated-x-axis and a rotated-y-axis that are in the horizontal plane;
calculating a primary azimuth that is an angle between the X-axis and the rotated-x-axis; and
extracting, based on the x-axis tilt angle, the y-axis tilt angle, and the primary azimuth, an azimuth error angle included in the primary azimuth due to rotation by the converter.
